(19) United States
(12) Patent Application Publication
(10) Pub. No.: US 2017/0343381 A1
(43) Pub. Date: Nov. 30, 2017

(54) ROTATION ANGLE DETECTION DEVICE AND ROTATION ANGLE DETECTION UNIT USING SAME

(71) Applicant: Panasonic Intellectual Property Management Co. Ltd., Osaka (JP)

(72) Inventor: YASUHIRO YAMASHITA, Osaka (JP)

(21) Appl. No.: 15/535,568

(22) PCT Filed: Dec. 22, 2015
(86) PCT No.: PCT/JP2015/006383

§ 371 Date: Jun. 13, 2017

(30) Foreign Application Priority Data
Jan. 5, 2015 (JP) 2015-000056

(51) Int. Cl. G01D 5/14; G01D 5/165; B62D 15/02

(52) U.S. Cl. CPC G01D 5/145; B62D 15/0215; G01D 5/165

(57) ABSTRACT

A rotation angle detection device of the present disclosure includes, a rotating body having a cylinder and configured to rotate with rotation of a rotating shaft coupled to an inside of the cylinder, an engagement protrusion provided inside of the cylinder of the rotating body and protruding in a first direction serving as a direction in which the rotating shaft extends, an elastic member mounted to the engagement protrusion and having an elastic holding part, a case having a rotation supporting part that rotatably supports the rotating body, and a rotation angle detector configured to detect a rotation angle of the rotating body. A predetermined gap is provided between the rotation supporting part of the case and an outer periphery of the cylinder of the rotating body. A fitting part protruding in a second direction perpendicular to the first direction is formed on an outer periphery of the engagement protrusion. The elastic member is mounted to the engagement protrusion so that the elastic holding part can be elastically deformed in a rotating direction of the fitting part.

### TECHNICAL FIELD

The present disclosure relates to a rotation angle detection device that mainly detects rotation of a rotating shaft, such as a steering shaft, within an automobile.

### BACKGROUND ART

With an advance in functions of an automobile in recent years, a rotation angle detection device detects a rotation angle of a rotating shaft, such as a steering shaft or a wheel steering pinion shaft, within the automobile, thereby performing various kinds of travel control or operation control of a vehicle body.

A conventional rotation angle detection device is described with reference to FIG. 11. FIG. 11 is a configuration view of the conventional rotation angle detection device. In FIG. 11, rotating body 2 with a gear formed on an outer periphery is rotatably mounted to case 1.

First detection body 4 meshes and interlocks with the outer periphery of rotating body 2, and second detection body 5 meshes and interlocks with first detection body 4. Also, first detection body 4 and second detection body 5 are mounted to case 1 so as to be rotatable according to rotation of rotating body 2.

Magnet 6 is fixed to a center of first detection body 4, and magnet 7 is fixed to a center of second detection body 5. Also, a magnetism detection element (not shown), such as an AMR (Anisotropic Magneto Resistive) element, is disposed facing magnet 6, and a magnetism detection element (not shown), such as an AMR (Anisotropic Magneto Resistive) element, is disposed facing magnet 7. The conventional rotation angle detection device is configured as described above.

In the aforementioned conventional rotation angle detection device, engagement protrusion 2A formed on an inner periphery of rotating body 2 is engaged with groove 3A formed on an outer periphery of steering shaft 3. Also, rotating body 2 is rotatable along with rotation of steering shaft 3. It should be noted that rotating body 2 is mounted within an automobile.

Also, changes in lines of magnetic force of magnet 6 and magnet 7 accompanied by rotations of first detection body 4 and second detection body 5 interlocking with the rotation of rotating body 2 are detected by the corresponding magnetism detection elements. Then, the magnetism detection elements output detection signals. A rotation angle of rotating body 2 is detected from the detection signals output from the magnetism detection elements. Also, data about the rotation angle is transmitted to a control device of a vehicle body, thereby performing various kinds of vehicle body control or operation control.

It should be noted that PTL 1, for example, is known as a citation list relating to this application.

### CITATION LIST

### Patent Literature

PTL 1: Unexamined Japanese Patent Publication No. 2004-271427

### SUMMARY OF THE INVENTION

A rotation angle detection device of the present disclosure includes a rotating body having a cylinder and configured to rotate with rotation of a rotating shaft coupled to an inside of the cylinder, an engagement protrusion provided inside of the cylinder of the rotating body and protruding in a first direction serving as a direction in which the rotating shaft extends, an elastic member mounted to the engagement protrusion and having an elastic holding part, a case having a rotation supporting part that rotatably supports the rotating body, and a rotation angle detector configured to detect a rotation angle of the rotating body. Also, in this rotation angle detection device, a predetermined gap is provided between the rotation supporting part of the case and an outer periphery of the cylinder of the rotating body. A fitting part protruding in a second direction perpendicular to the first direction is formed on an outer periphery of the engagement protrusion. The elastic member is mounted to the engagement protrusion so that the elastic holding part can be elastically deformed in a rotating direction of the fitting part.

Further, a rotation angle detection unit of the present disclosure includes the aforementioned rotation angle detection device, and the rotating shaft coupled to the rotating body of the rotation angle detection device. Also, in this rotation angle detection unit, an engagement recess having a fitted part is provided at a tip of the rotating shaft, and the fitted part corresponds to the fitting part. A shape of the engagement recess is larger than an outer shape of the engagement protrusion formed in the rotating body. The elastic holding part of the elastic member elastically contacts an inner surface of the fitted part of the engagement recess. The fitting part and the fitted part are fitted to each other, and the engagement recess of the rotating shaft engages with the engagement protrusion of the rotating body.

### BRIEF DESCRIPTION OF DRAWINGS

FIG. 1 is a sectional view of a rotation angle detection device according to an exemplary embodiment of the present disclosure.

FIG. 2 is an exploded perspective view of the rotation angle detection device according to the exemplary embodiment of the present disclosure.

FIG. 3A is a perspective view showing a method for mounting a rotating body and an elastic member of the rotation angle detection device according to the exemplary embodiment of the present disclosure.

FIG. 3B is a perspective view showing the method for mounting the rotating body and the elastic member of the rotation angle detection device according to the exemplary embodiment of the present disclosure.

FIG. 4 is a perspective view of a case of the rotation angle detection device according to the exemplary embodiment of the present disclosure.

FIG. 5 is a perspective view of the rotation angle detection device and a rotating shaft according to the exemplary embodiment of the present disclosure.

FIG. 6 is a sectional view of a rotation detection unit in a planar view according to the exemplary embodiment of the present disclosure.

FIG. 7 is a sectional view of a main part of the rotation detection unit according to the exemplary embodiment of the present disclosure.

FIG. 8A is a sectional view of the main part of the rotation detection unit according to the exemplary embodiment of the present disclosure.

FIG. 8B is a sectional view of the main part of the rotation detection unit according to the exemplary embodiment of the present disclosure.

FIG. 9A is a perspective view of an elastic member according to a modification of the exemplary embodiment of the present disclosure.

FIG. 9B is a perspective view of the elastic member according to the modification of the exemplary embodiment of the present disclosure.

FIG. 10 is a sectional view of a main part of a rotation angle detection unit according to the exemplary embodiment of the present disclosure.

FIG. 11 is a configuration view of a conventional rotation angle detection device.

### DESCRIPTION OF EMBODIMENTS

Prior to explanation of a rotation angle detection device according to the present exemplary embodiment, a technical problem described in PTL 1 is described.

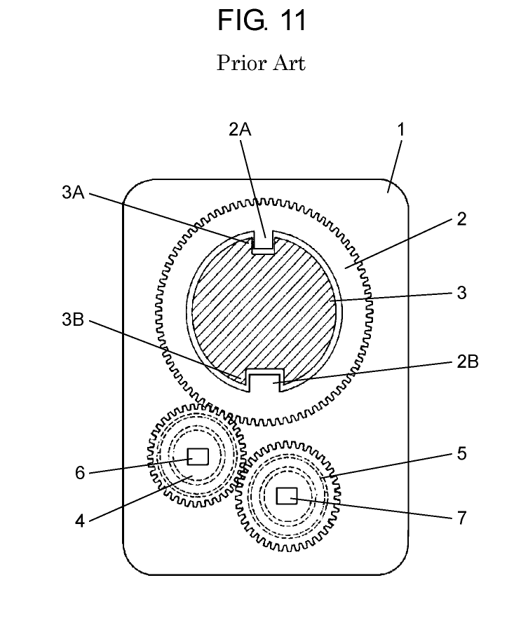

In the conventional rotation angle detection device described with reference to FIG. 11, eccentricity or shaft deviation of steering shaft 3 occurs during the rotation of steering shaft 3. Accordingly, in order to allow the eccentricity or the shaft deviation of steering shaft 3, a gap is provided between groove 3A and engagement protrusion 2A and between groove 3B and engagement protrusion 2B. By providing the gaps, groove 3A and engagement protrusion 2A and groove 3B and engagement protrusion 2B are respectively engaged with each other.

Therefore, play during the rotation is large between steering shaft 3 and rotating body 2. There is a problem in that, with respect to an actual rotation angle of steering shaft 3, a large error is caused in the rotation angle of rotating body 2 detected from the rotations of first detection body 4 and second detection body 5 that interlock with the rotation of rotating body 2.

An object of the present disclosure is to provide a rotation angle detection device that detects a rotation angle of a rotating shaft coupled to a rotating body with high accuracy and a rotation angle detection unit using same.

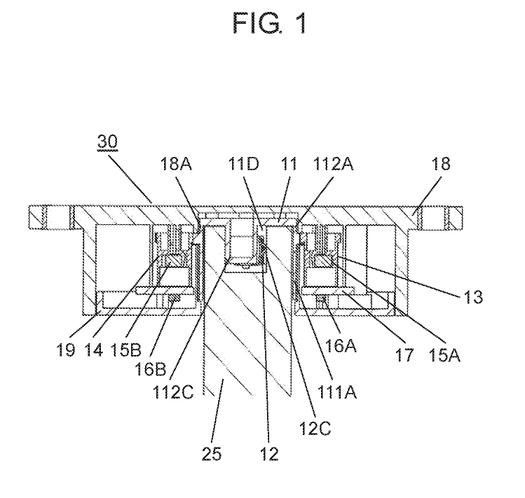

Exemplary embodiments of the present disclosure are described below with reference to FIGS. 1 to 10.

### Exemplary Embodiments

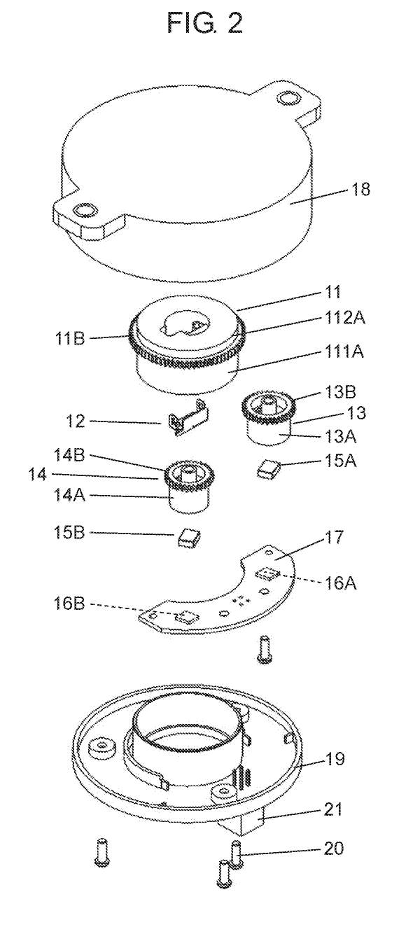

FIG. 1 is a sectional view of a rotation angle detection device according to an exemplary embodiment of the present disclosure. FIG. 2 is an exploded perspective view of the rotation angle detection device according to the exemplary embodiment of the present disclosure.

Rotating body 11 is made of a synthetic resin, such as polyoxymethylene (hereinafter described as POM). Also, rotating body 11 has cylinder 111A, gear 11B, and cylinder 112A. Cylinder 111A is cylindrical and opened downward. Gear 11B is formed on an outer periphery of an upper part of cylinder 111A, and cylinder 112A is formed on an upper part of gear 11B. Also, cylinder 111A and cylinder 112A are coaxial.

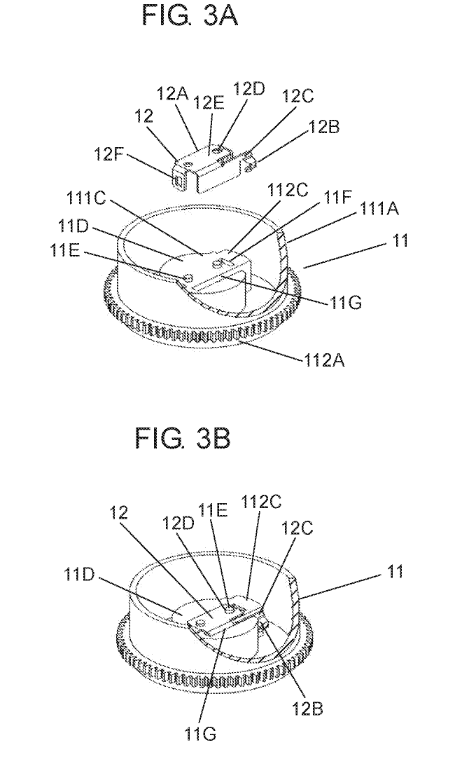

FIGS. 3A and 3B are perspective views of rotating body 11 and elastic member 12 as seen from below. It should be noted that FIG. 3A shows a state before elastic member 12 is mounted to rotating body 11, and FIG. 3B shows a state after elastic member 12 is mounted to rotating body 11.

As shown in FIGS. 3A and 3B, engagement protrusion 11D is formed inside of cylinder 111A of rotating body 11. Engagement protrusion 11D has column 111C and fitting part 112C. Column 111C is substantially columnar, and is coaxial with cylinder 111A and cylinder 112A. Fitting part 112C protrudes in a substantially U-shape in a radial direction from a part of an outer periphery of column 111C.

Elastic member 12 is made of an elastic metal plate, such as beryllium copper or phosphor bronze. Also, elastic member 12 is substantially U-shaped as viewed from a side, and has base 12A and elastic holding part 12C. Base 12A has base surface 12E and locking hole parts 12F bending to both sides of base surface 12E. Elastic holding part 12C is bent from one side of base surface 12E. Moreover, protrusion 12B is provided at a tip of elastic holding part 12C. Protrusion 12B is substantially orthogonal to an extending direction of elastic holding part 12C, and protrudes outward from elastic holding part 12C. A plurality of positioning holes 12D is formed on base surface 12E.

Next, a method for mounting elastic member 12 to engagement protrusion 11D of rotating body 11 is described with reference to FIGS. 3A and 3B.

As shown in FIG. 3A, two positioning protrusions 11E are formed on a lower surface of engagement protrusion 11D (since FIG. 3A is a view seen from below, the lower surface is shown as an upper surface in FIG. 3A). Moreover, two through holes 11F are formed on sides of two positioning protrusions 11E on the lower surface of engagement protrusion 11D. Each through hole 11F is recessed upward from the lower surface (recessed downward from the upper surface in FIGS. 3A and 3B), and is formed with a locking protrusion (not shown) on an inner surface. Locking groove 11G is formed parallel to two through holes 11F. It should be noted that one of two through holes 11F is disclosed and that the other through hole is hidden behind the cylinder and only partially disclosed in FIG. 3A.

As shown in FIG. 3B, positioning holes 12D of elastic member 12 are inserted into positioning protrusions 11E of engagement protrusion 11D, respective locking hole parts 12F are inserted into corresponding through holes 11F, and an end of elastic holding part 12C is held within locking groove 11G. Further, elastic holding part 12C is inserted into locking groove 11G. In this way, base 12A of elastic member 12 is positioned to engagement protrusion 11D. Further, each locking hole part 12F is locked in the locking protrusion (not shown) within through hole 11F, and is locked and fixed to engagement protrusion 11D. In this way, elastic member 12 is mounted to engagement protrusion 11D.

As shown in FIG. 3B, in a mounted state in which elastic member 12 is mounted to engagement protrusion 11D, protrusion 12B formed at the tip of elastic holding part 12C is disposed substantially parallel to one side surface of fitting part 112C, and extends so as to be elastically deformable in a rotating direction of fitting part 112C.

Also, detection body 13 and detection body 14 shown in FIGS. 1 and 2 are formed of a synthetic resin, such as POM. Detection body 13 has cylinder 13A that is cylindrical and opened downward, and detection body 14 has cylinder 14A that is cylindrical and opened downward. Gear 13B is formed on an upper part of cylinder 13A, and gear 14B is formed on an upper part of cylinder 14A. It should be noted that a number of teeth of gear 13B and a number of teeth of gear 14B are different. Neodymium-based magnet 15A is mounted substantially to a center inside cylinder 13A, and neodymium-based magnet 15B is mounted substantially to a center inside cylinder 14A.

Magnetism detector 16A is formed by integrating a magnetism detection element, such as a Hall element or an AMR (Anisotropic Magneto Resistive) element, and a control circuit. Magnetism detector 16A is disposed on a lower surface of wiring substrate 17 so as to face magnet 15A at a predetermined interval. Similarly, magnetism detector 16B is formed by integrating a magnetism detection element, such as a Hall element or an AMR (Anisotropic Magneto Resistive) element, and a control circuit. Magnetism detector 16B is disposed on the lower surface of wiring substrate 17 so as to face magnet 15B at a predetermined interval. Moreover, wiring substrate 17 is mounted with various electronic components (not shown), such as a resistor and a capacitor. A rotation angle detector is configured with detection bodies 13, 14, magnets 15A, 15B, and magnetism detectors 16A, 16B.

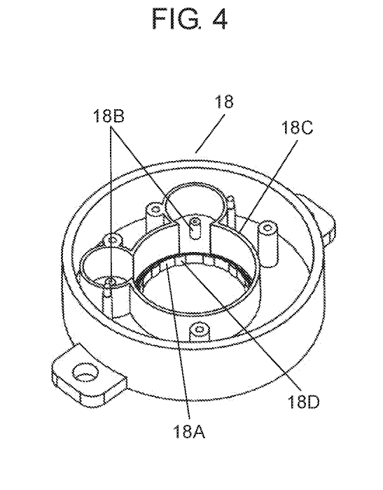

Next, a configuration of case 18 is described in detail with reference to FIG. 4. FIG. 4 is a perspective view of case 18 as seen from below. Case 18 is made of a synthetic resin, such as polybutylene terephthalate (hereinafter described as PBT).

Case 18 has an opening substantially in a center, and a rotation supporting part 18A (see FIG. 3A) for rotatably supporting cylinder 112A (see FIG. 2) of rotating body 11 is disposed at a peripheral edge of the opening. Further, shafts 18B for rotatably supporting detection bodies 13, 14 (see FIG. 2) are disposed near rotation supporting part 18A. Wall 18C is formed so as to surround cylinder 111A (see FIG. 3A) and cylinders 13A, 14A (see FIG. 2) of detection bodies 13, 14.

A plurality of curved sliding contact parts 18D protruding inward at predetermined intervals in a circumferential direction is formed on an inner peripheral side surface of rotation supporting part 18A. Sliding contact parts 18D are a part of rotation supporting part 18A. Further, sliding contact parts 18D need not necessarily be provided, and the inner peripheral side surface of rotation supporting part 18A may be flat.

In the present exemplary embodiment, sliding contact parts 18D are formed so that respective vertexes protruding inward are disposed on a same circle with a predetermined radius.

It should be noted that rotation supporting part 18A is provided so that a gap between rotation supporting part 18A and cylinder 112A is as small as possible and that rotation supporting part 18A rotatably supports rotating body 11.

Also, gear 13B of detection body 13 and gear 14B of detection body 14 are meshed with gear 11B of rotating body 11. Detection bodies 13, 14 are disposed so that detection body 13 and detection body 14 rotate interlocking with the rotation of rotating body 11.

It should be noted that, regarding diameters and numbers of teeth of rotating body 11 and detection bodies 13, 14, rotating body 11 has the largest diameter and number of teeth and detection body 14 has the smallest diameter and number of teeth.

Further, a lower surface opening of case 18 is covered with cover 19 (see FIG. 2). Also, cover 19 and case 18 are fixed by screws 20. Rotation angle detection device 30 is configured as described above.

Also, for example, rotation angle detection device 30 is mounted to a vicinity of a drive part (not shown) for steering wheels in right and left directions in a vehicle body, and is connected to a controller (not shown) of the vehicle body from connector 21 via a lead wire or the like.

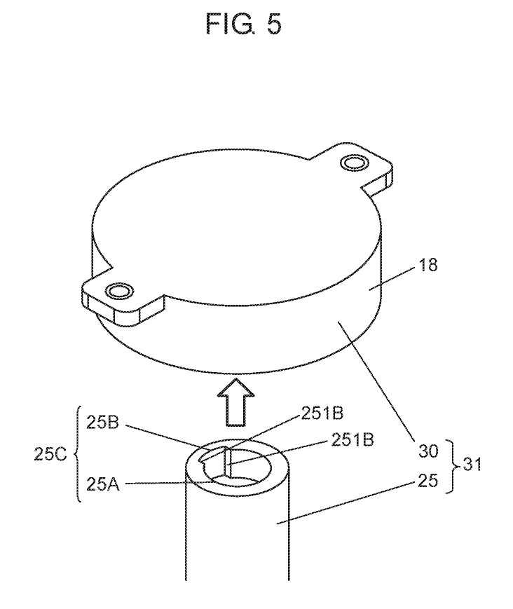

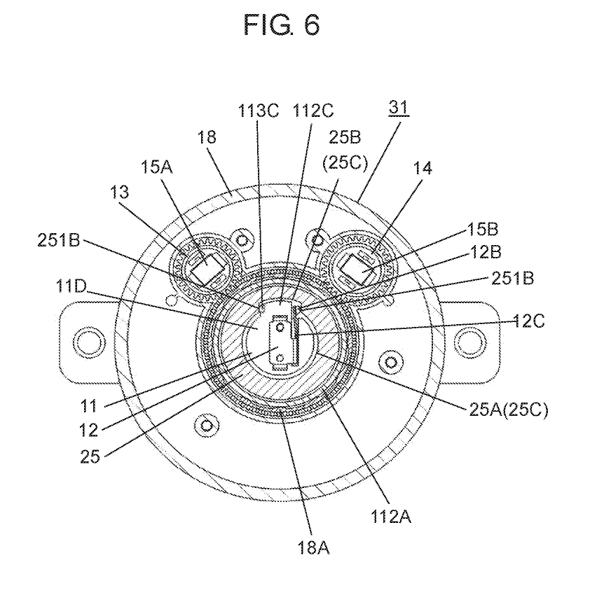

Moreover, as shown in a perspective view of FIG. 5 and a sectional view of FIG. 6, rotating shaft 25 is inserted into cylinder 111A of rotating body 11, and is then coupled to rotating body 11 of rotation angle detection device 30. Rotating shaft 25 is, for example, a synthetic resin steering shaft that rotates according to operation of a steering or a metal pinion shaft that rotates according to the steering of wheels.

Engagement recess 25C including inner cylinder 25A and fitted part 25B is formed at a tip of rotating shaft 25. An inner diameter of inner cylinder 25A is slightly larger than an outer diameter of column 111C (see FIG. 3A) of engagement protrusion 11D. Fitted part 25B is recessed outward from a part of inner cylinder 25A substantially in a U-shape, and fitting part 112C (see FIG. 3A) is inserted into fitted part 25B.

It should be noted that two inner surfaces 251B facing each other in a rotating direction of fitted part 25B are formed in planar shapes and substantially parallel to a predetermined straight line passing through a shaft center of rotating shaft 25.

Also, when rotating shaft 25 is inserted into cylinder 111A, as shown in FIG. 6, protrusion 12B of elastic holding part 12C mounted to engagement protrusion 11D elastically contacts one inner surface 251B of fitted part 25B with respect to engagement recess 25C of rotating shaft 25. Further, curved or spherical protrusion 113C provided on a side surface of fitting part 112C abuts on other inner surface 251B of fitted part 25B. In this way, fitting part 112C fits into fitted part 25B, and entire engagement protrusion 11D is engaged with an inside of engagement recess 25C.

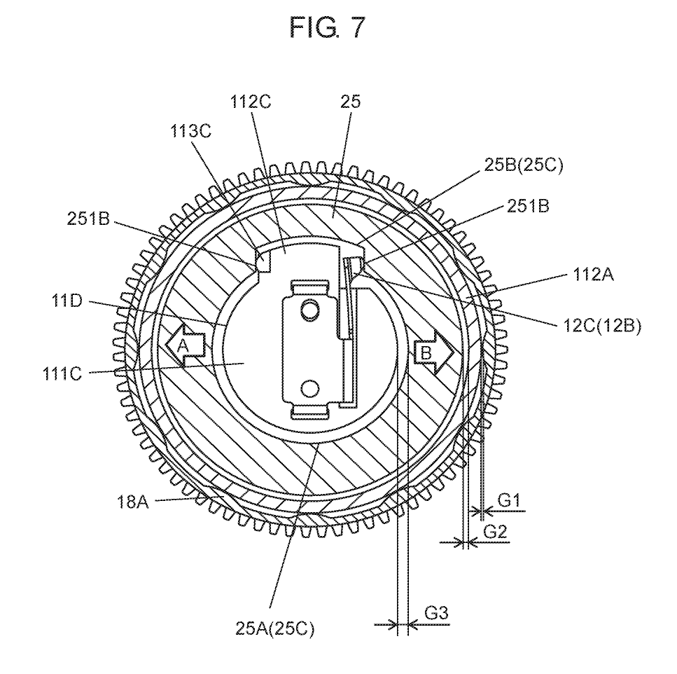

As shown in a sectional view of a main part in FIG. 7, it should be noted that gap G3 between column 111C of engagement protrusion 11D and inner cylinder 25A of engagement recess 25C, and gap G2 between an outer periphery of rotating shaft 25 and an inner periphery of cylinder 112A are set larger than gap G1 between an inner periphery of rotation supporting part 18A and an outer periphery of cylinder 112A of rotating body 11. Further, sizes of gap G3 and gap G2 are set larger than a size of eccentricity or shaft deviation that occurs during rotation of rotating shaft 25. However, a side surface of fitting part 112C is not a setting target of gap G3.

Therefore, in a case where the eccentricity or the shaft deviation occurs when rotating shaft 25 rotates within cylinders 111A, 112A, rotating shaft 25 is held in a rotating direction in a state in which elastic holding part 12C elastically contacts inner surface 251B of fitted part 25B of rotating shaft 25 and fitting part 112C fits into fitted part 25B. On the other hand, rotating shaft 25 sways within gaps G2, G3 between rotating shaft 25 and rotating body 11 in a direction substantially orthogonal to a shaft center direction. However, inner cylinder 25A of rotating shaft 25 does not abut on column 111C of rotating body 11. Further, the outer periphery of rotating shaft 25 does not abut on the inner periphery of cylinder 112A. The same applies to cylinder 111A. Similar to cylinder 112A, the outer periphery of rotating shaft 25 does not abut on an inner periphery of cylinder 111A. Also, the rotation of rotating body 11 is regulated by the inner periphery of rotation supporting part 18A and the outer periphery of cylinder 112A of rotating body 11 so that rotation eccentricity or shaft deviation of rotating body 11 itself is as small as possible.

Further, pressing force on inner surface 251B of fitted part 25B by elastic holding part 12C is larger than operating force required for the rotation of rotating body 11. The operating force includes torque for driving detection body 13 and detection body 14 within rotation angle detection device 30, frictional force of rotating body 11 itself, and the like.

Therefore, when rotating shaft 25 rotates, elastic holding part 12C of fitting part 112C and an opposite side surface of fitting part 112C always contact facing inner surfaces 251B of fitted part 25B with respect to fitted part 25B of rotating shaft 25. Hence, rotating body 11 reliably rotates following the rotation of rotating shaft 25.

As mentioned above, rotating shaft 25 is coupled to rotating body 11 of rotation angle detection device 30, thereby configuring rotation angle detection unit 31.

In other words, as mentioned above, rotation angle detection device 30 of the present exemplary embodiment has rotating body 11 having cylinders 111A, 112A and for rotating with the rotation of rotating shaft 25 coupled to the inside of cylinders 111A, 112A. Further, rotation angle detection device 30 has engagement protrusion 11D, elastic member 12, case 18, and the rotation angle detector. Engagement protrusion 11D is provided inside of cylinder 111A of rotating body 11, and protrudes in a first direction serving as a direction in which rotating shaft 25 extends (an up and down direction in FIGS. 3A, 3B, and 5). Elastic member 12 is mounted to engagement protrusion 11D, and has elastic holding part 12C. Case 18 has rotation supporting part 18A for rotatably supporting rotating body 11. The rotation angle detector (detection bodies 13, 14, magnets 15A, 15B, and magnetism detectors 16A, 16B) detects a rotation angle of rotating body 11.

Also, in rotation angle detection device 30, predetermined gap G1 is provided between rotation supporting part 18A of case 18 and the outer peripheries of cylinders 111A, 112A of rotating body 11, and fitting part 112C protruding in a second direction perpendicular to the first direction is formed on the outer periphery of engagement protrusion 11D. Further, in rotation angle detection device 30, elastic member 12 is mounted to engagement protrusion 11D so that elastic holding part 12C is elastically deformable in the rotating direction of fitting part 112C.

Further, in rotation angle detection device 30 of the present exemplary embodiment, it is more preferable that elastic member 12 be configured so that base 12A locked to engagement protrusion 11D and elastic holding part 12C formed on the side of base 12A are integrally formed. [Operation of Rotation Angle Detection Unit 31]

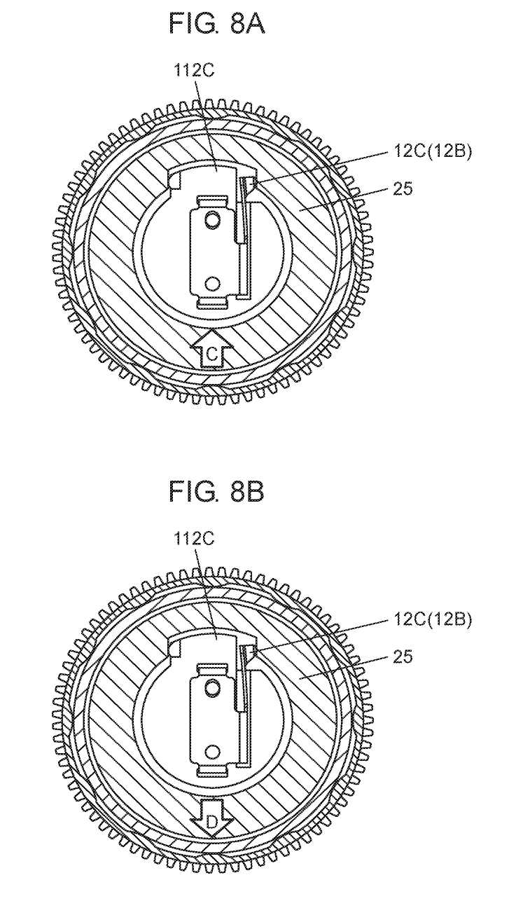

Next, operation of rotation angle detection unit 31 configured as above is described with reference to a sectional view in a planar view of FIG. 6 and sectional views of main parts of FIGS. 7 to 8B.

For example, as shown in FIG. 6 or 7, a steering wheel is first rotated rightward by a driver from a state in which the steering wheel is located at a neutral position. Then, wheels of a vehicle body are steered rightward according to this rotation, and rotating shaft 25 is rotated according to this steering angle.

At this time, engagement protrusion 11D is rotated by fitting part 112C of rotating body 11 fitted into fitted part 25B via fitted part 25B of rotating shaft 25. Accordingly, rotating body 11 is rotated.

Further, detection bodies 13, 14 rotate interlocking with the rotation of rotating body 11. Then, magnetism detector 16A detects a change in lines of magnetic force of magnet 15A, and magnetism detector 16B detects a change in lines of magnetic force of magnet 15B. A rotation angle of rotating body 11, that is, a rotation angle of rotating shaft 25, is detected from detection signals output from magnetism detectors 16A, 16B. Data of the rotation angle is output to the controller of the vehicle body, and various kinds of control of the vehicle body are performed.

In other words, since the number of teeth of the gear included in detection body 13 and the number of teeth of the gear included in detection body 14 are different, shapes of signal waveforms output from the two magnetism detection elements (not shown) are different from each other. Detection signals having phase difference are obtained. Magnetism detectors 16A, 16B perform predetermined operation from these two different detection signals and the numbers of teeth of the gears included in rotating body 11 and detection bodies 13, 14. Accordingly, the rotation angle of rotating body 11, that is, the rotation angle of rotating shaft 25, is detected.

At this time, for example, as shown in FIG. 7, eccentricity or shaft deviation assumed to occur in rotating shaft 25 in a direction of arrow A or arrow B during the rotation. Since fitting part 112C of rotating body 11 is fitted into fitted part 25B of rotating shaft 25 by elastic holding part 12C, rotating shaft 25 and rotating body 11 are held in the respective rotating directions. On the other hand, the eccentricity or the shaft deviation occurs in rotating shaft 25 within ranges of gaps G2, G3 between rotating shaft 25 and rotating body 11. However, the eccentricity or the shaft deviation has little influence on the rotation of rotating body 11. Accordingly, the rotation of rotating shaft 25 is reliably transmitted to rotating body 11, and rotating body 11 is supported by rotation supporting part 18A so as to rotate in a state in which the eccentricity or the shaft deviation is small. Therefore, the rotation angle of rotating body 11 detected by detection bodies 13, 14 interlocking with rotating body 11 has a small error with respect to the rotation angle of rotating shaft 25. As it is obvious from the above description, the rotation angle is detected with high accuracy in rotation angle detection unit 31 of the present exemplary embodiment.

Further, for example, as shown in the sectional views of the main parts of FIGS. 8A and 8B, when rotating shaft 25 becomes eccentric in a direction of arrow C or D, rotating shaft 25 sways in the direction of arrow C or D within the ranges of gaps between rotating shaft 25 and rotating body 11 as with a case where rotating shaft 25 becomes eccentric in the direction of arrow A or B. Even in this case, the eccentricity has little influence on the rotation of rotating body 11. Hence, the rotation angle of rotating shaft 25 also has a small detection error regarding the eccentricity of rotating shaft 25 in the direction of arrow C or D, and the rotation angle is detected with high accuracy.

In this way, according to the present exemplary embodiment, engagement protrusion 11D protruding in a shaft direction (the first direction) of rotating body 11 is provided inside of cylinders 111A, 112A of rotating body 11, and fitting part 112C protruding in a radial direction (the second direction) is provided on the outer periphery of engagement protrusion 11D. Also, elastic member 12 formed with elastic holding part 12C is mounted to engagement protrusion 11D so that elastic holding part 12C is elastically deformable in the rotating direction of fitting part 112C. Accordingly, rotation angle detection device 30 is configured. Further, engagement recess 25C is provided at the tip of rotating shaft 25. Engagement recess 25C is formed with fitted part 25B corresponding to fitting part 112C, and has a shape larger than an outer shape of engagement protrusion 11D of rotating body 11. Elastic holding part 12C of elastic member 12 elastically contacts at least one inner surface 251B in the rotating direction of fitted part 25B, fitting part 112C and fitted part 25B are fit into each other, and engagement recess 25C of rotating shaft 25 is engaged. In this way, rotating shaft 25 is coupled to rotating body 11 of rotation angle detection device 30, thereby configuring rotation angle detection unit 31.

According to rotation angle detection unit 31 of the aforementioned present exemplary embodiment, the rotation of rotating shaft 25 is reliably transmitted to rotating body 11 via fitted part 25B and fitting part 112C. At this time, rotating shaft 25 is maintained in a rotated state.

Hence, the eccentricity or the rotation deviation of rotating shaft 25 is absorbed by the inside of cylinder 111A of rotating body 11. Further, rotating body 11 is regulated by rotation supporting part 18A of case 18, and is hardly affected by the eccentricity or the shaft deviation of rotating shaft 25. Hence, according to the present exemplary embodiment, the rotation angle detection device that detects the rotation angle of rotating shaft 25 with high accuracy and the rotation angle detection unit using the same can be realized.

Further, elastic member 12 is configured by integrally forming base 12A substantially U-shaped in the side view and elastic holding part 12C provided on the one side of base 12A. By engaging base 12A with engagement protrusion 11D, elastic member 12 is mounted to engagement protrusion 11D easily and reliably. Elastic member 12 is stably mounted to engagement protrusion 11D, and the rotation angle can be detected reliably.

Further, in other words, rotation angle detection unit 31 of the present disclosure has aforementioned rotation angle detection device 30 and rotating shaft 25 coupled to rotating body 11 of rotation angle detection device 30. Also, in this rotation angle detection unit 31, engagement recess 25C having fitted part 25B is provided at the tip of rotating shaft 25, and the shape of engagement recess 25C is larger than the outer shape of engagement protrusion 11D formed at rotating body 11. Elastic holding part 12C of elastic member 12 elastically contacts inner surface 251B of fitted part 25B of engagement recess 25C, fitting part 112C and fitted part 25B fit into each other, and engagement recess 25C of rotating shaft 25 engages with engagement protrusion 11D of rotating body 11.

Further, in rotation angle detection unit 31 of the present disclosure, it is more preferable that gap G1 between rotation supporting part 18A of case 18 and the outer periphery of cylinder 112A of rotating body 11 be smaller than gap G2 between the outer periphery of rotating shaft 25 and the inner periphery of cylinder 112A. Moreover, in this rotation angle detection unit 31, it is more preferable that gap G1 between rotation supporting part 18A of case 18 and the outer periphery of cylinder 112A of rotating body 11 be smaller than gap G3 between engagement recess 25C of rotating shaft 25 and engagement protrusion 11D. For example, a length of G2 is 0.75 mm and a length of G3 is 1.0 mm, whereas a length of G1 is 0.1 mm In other words, gap G1 between rotation supporting part 18A and the outer periphery of cylinder 112A of rotating body 11 is extremely smaller than gap G2 between the outer periphery of rotating shaft 25 and the inner periphery of cylinder 112A. Hence, although it is disclosed as if cylinder 112A contacts rotation supporting part 18A at sliding contact parts 18D in FIGS. 7 to 8B, there is actually a small gap between rotation supporting part 18A (sliding contact parts 18D) and cylinder 112.

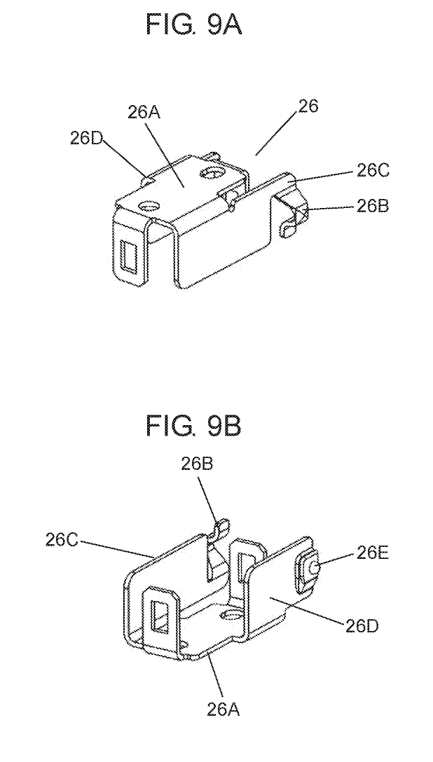

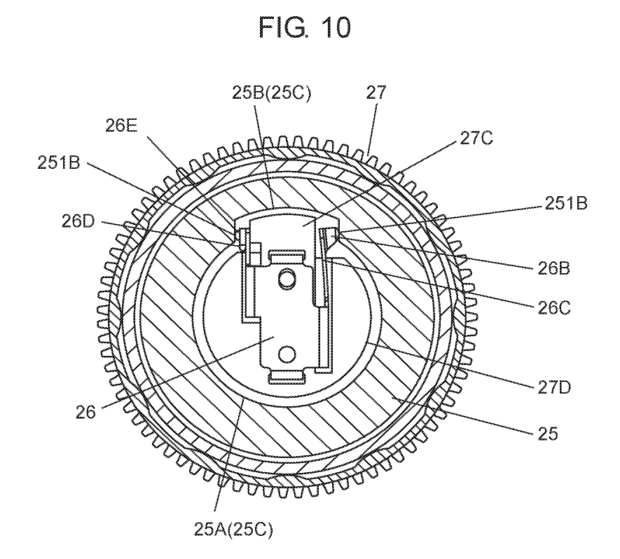

Next, another exemplary embodiment of elastic member 12 in rotation angle detection unit 31 of the aforementioned present exemplary embodiment is described with reference to FIGS. 9A to 10. It should be noted that the same reference marks are assigned to configurations identical to the configurations in the exemplary embodiment described with reference to FIGS. 1 to 8B, and description of the configurations are omitted.

FIG. 9A is a perspective view of elastic member 26 as seen from above. FIG. 9B is a perspective view of elastic member 26 as seen from below. FIG. 10 is a sectional view of a main part of rotation angle detection unit. As shown in FIGS. 9A to 10, elastic member 26 is mounted to engagement protrusion 27D. Also, elastic holding part 26C is bent from one side of base 26A of elastic member 26. Further, abutting part 26D is bent from another side of base 26A. Also, it is possible to implement the present invention by a configuration in which elastic holding part 26C elastically contacts one inner surface 251B of fitted part 25B, and abutting part 26D abuts on another inner surface 251B of fitted part 25B.

In other words, as shown in FIGS. 9A and 9B, elastic holding part 26C with protrusion 26B formed at a tip is provided on the one side of base 26A, and abutting part 26D is bent and formed on the other side of base 26A in elastic member 26. Also, protrusion 26E is formed at a tip of abutting part 26D.

As shown in FIG. 10, elastic member 26 is mounted to engagement protrusion 27D of rotating body 27. Also, elastic holding part 26C is disposed on one side surface of fitting part 27C so as to be elastically deformable in a rotating direction, and abutting part 26D is disposed on another side surface of fitting part 27C. Also, elastic holding part 26C elastically contacts one inner surface 251B in a rotating direction of fitted part 25B of rotating shaft 25, and abutting part 26D abuts on other inner surface 251B.

In a case where rotating shaft 25 is made of metal, elastic member 26 made of an elastic metal plate elastically contacts or abuts on inner surfaces 251B of fitted part 25B. Hence, when rotating body 27 rotates, contact between elastic member 26 and fitted part 25B becomes contact between metals. Accordingly, wear or the like hardly occurs at these contact portions, and fitting between fitted part 25B and fitting part 27C is stable.

It should be noted that elastic holding part 12C is provided on the one side of elastic member 12 in the exemplary embodiment described with reference to FIGS. 1 to 8B. However, elastic holding part 12C may be provided on both sides of elastic member 12. One of two elastic holding parts 12C may elastically contact one inner surface 251B of fitted part 25B and other elastic holding part 12C may elastically contact other inner surface 251B of fitted part 25B.

It should be noted that the aforementioned exemplary embodiment has been described using an example in which elastic member 12 (or 26) is locked and fixed to engagement protrusion 11D (or 27D), and mounted. However, elastic member 12 (or 26) may be insert-molded, adhered, welded, or the like to engagement protrusion 11D (or 27D) so that elastic holding part 12 (or 26) extends to a side of fitting part 112C (or 27C) and is disposed so as to be elastically deformable in the rotating direction.

It should be noted that elastic member 12 (or 26) may be formed of steel wire for spring, such as piano wire, stainless steel wire, or hard steel wire.

Further, for example, gap G3 between engagement protrusion 11D and engagement recess 25C excluding the both side surfaces of fitting part 112C and gap G2 between the outer periphery of rotating shaft 25 and the inner peripheries of cylinders 111A, 112A are respectively set larger than gap G1 between the inner periphery of rotation supporting part 18A and the outer periphery of cylinder 112A of rotating body 11. With this configuration, eccentricity or shaft deviation during rotation of rotating shaft 25 occurs only within rotating body 11, and the rotation of rotating body 11 is regulated by rotation supporting part 18A, thereby reducing rotation eccentricity or shaft deviation of rotating body 11.

Further, the aforementioned exemplary embodiment has been described using an example in which engagement recess 25C including one fitted part 25B recessed substantially in the U-shape is formed outside of inner cylinder 25A of rotating shaft 25. However, a plurality of fitted parts 25B recessed substantially in U-shapes may be radially disposed outside of inner cylinder 25A on a same radius from the shaft center.

With this configuration, when engagement protrusion 11D (or 27D) of rotating body 11 (or 27) is coupled to engagement recess 25C of rotating shaft 25, the coupling can be performed by fitting one fitting part 112C (or 27C) into one of plurality of fitted parts 25B. Hence, in this configuration, it is easier to incorporate rotating shaft 25 into rotation angle detection device 30.

It should be noted that the aforementioned exemplary embodiment has been described using an example in which rotation supporting part 18A is provided in case 18. However, the rotation supporting part may be provided in cover 19 and this rotation supporting part may rotatably support cylinder 111A of rotating body 11.

Further, in the aforementioned exemplary embodiment, detection body 13 and detection body 14 are meshed with the gear of rotating body 11, and the rotation angle of rotating body 11 is detected from the rotations of detection body 13 and detection body 14 interlocking with rotating body 11. However, detection body 13 may be meshed with rotating body 11 and detection body 14 may be meshed with detection body 13, so that the rotation angle of rotating body 11 may be detected from the rotations of detection body 13 and detection body 14 interlocking with the rotation of rotating body 11.

As described above, according to the present disclosure, elastic holding part 12C of elastic member 12 elastically contacts fitted part 25B of rotating shaft 25, and fitting part 112C of the rotating body fits into fitted part 25B of rotating shaft 25. With this configuration, the rotation of rotating shaft 25 is reliably transmitted to rotating body 11 via fitted part 25B and fitting part 112C held in the rotating direction. Hence, the eccentricity or the rotation deviation of rotating shaft 25 is absorbed by the inside of cylinder 111A of rotating body 11, and rotating body 11 is regulated by rotation supporting part 18A of case 18 to rotate. Hence, rotating body 11 is hardly affected by the eccentricity or the shaft deviation of rotating shaft 25.

Hence, the rotation angle detection device with the simple configuration that detects the rotation angle of rotating shaft 25 coupled to rotating body 11 with high accuracy and the rotation angle detection unit using the same can be obtained. It should be noted that the modification of the exemplary embodiment can also obtain similar effects.

### INDUSTRIAL APPLICABILITY

A rotation angle detection device and rotation angle detection unit using same according to the present disclosure are capable of detecting a rotation angle of a rotating shaft coupled to a rotating body with high accuracy, and are useful for detecting the rotation angle of the rotating shaft within an automobile.

### REFERENCE MARKS IN THE DRAWINGS

11, 27: rotating body

11B, 13B, 14B: gear

11D, 27D: engagement protrusion

11E: positioning protrusion

11F: through hole

11G: locking groove

12, 26: elastic member

12A, 26A: base

12B, 26B: protrusion

12C, 26C: elastic holding part

12D: positioning hole

12E: base surface

12F: locking hole part

13: detection body

13A, 14A: cylinder

14: detection body

15A, 15B: magnet

16A, 16B: magnetism detector

17: wiring substrate

18: case

18A: rotation supporting part

18B: shaft

18C: wall

18D: sliding contact part

19: cover

20: screw

21: connector

25: rotating shaft

25A: inner cylinder

25B: fitted part

25C: engagement recess

26D: abutting part

26E: protrusion

27C, 112C: fitting part

30: rotation angle detection device

31: rotation angle detection unit

111A: cylinder

111C: column

112A: cylinder

113C: protrusion

251B: inner surface

1. A rotation angle detection device comprising:
a rotating body having a cylinder and configured to rotate with rotation of a rotating shaft coupled to an inside of the cylinder;
an engagement protrusion provided inside of the cylinder of the rotating body and protruding in a first direction serving as a direction in which the rotating shaft extends;
an elastic member mounted to the engagement protrusion and having an elastic holding part;
a case having a rotation supporting part that rotatably supports the rotating body; and
a rotation angle detector configured to detect a rotation angle of the rotating body,
wherein a predetermined gap is provided between the rotation supporting part of the case and an outer periphery of the cylinder of the rotating body,
a fitting part protruding in a second direction perpendicular to the first direction is formed on an outer periphery of the engagement protrusion, and
the elastic member is mounted to the engagement protrusion so that the elastic holding part can be elastically deformed in a rotating direction of the fitting part.

2. The rotation angle detection device according to claim 1, wherein the elastic member is configured so that a base locked to the engagement protrusion and the elastic holding part formed on a side of the base are integrally formed.

3. A rotation angle detection unit comprising:
the rotation angle detection device according to claim 1; and
the rotating shaft coupled to the rotating body of the rotation angle detection device,
wherein an engagement recess having a fitted part is provided at a tip of the rotating shaft,
a shape of the engagement recess is larger than an outer shape of the engagement protrusion formed in the rotating body,
the elastic holding part of the elastic member elastically contacts an inner surface of the fitted part of the engagement recess,
the fitting part and the fitted part are fitted to each other, and
the engagement recess of the rotating shaft engages with the engagement protrusion of the rotating body.

4. The rotation angle detection unit according to claim 3, wherein
the gap between the rotation supporting part of the case and the outer periphery of the cylinder of the rotating body is smaller than a gap between an outer periphery of the rotating shaft and an inner periphery of the cylinder, and
the gap between the rotation supporting part of the case and the outer periphery of the cylinder of the rotating body is smaller than a gap between the engagement recess of the rotating shaft and the engagement protrusion.
